(19) United States
(12) Patent Application Publication
(10) Pub. No.: US 2026/0189560 A1
(43) Pub. Date: Jul. 2, 2026

(54) LABEL GENERATION TECHNIQUES FOR DEVICE STACKING FRAUD DETECTION

(71) Applicant: EQUIFAX INC., Atlanta, GA (US)

(72) Inventors: Yi Zhang, Johns Creek, GA (US); Jie Liu, Allen, TX (US); Cuizhen Shen, Duluth, GA (US); Adam Michael Ames, Pittsboro, NC (US); Dilip Singh, Alpharetta, GA (US)

(21) Appl. No.: 19/429,358

(22) Filed: Dec. 22, 2025

Related U.S. Application Data
(60) Provisional application No. 63/738,958, filed on Dec. 26, 2024.

(51) Int. Cl. H04L 9/40

(52) U.S. Cl. CPC H04L 63/10; H04L 63/1441

(57) ABSTRACT

A device stacking detection computing system receives single-provider data from a service provider computing system associated with a telecommunications service provider. The single-provider data describes a request for a digital device, such as a consumer request to receive a digital device for a new account. Based on the single-provider data, the device stacking detection computing system determines multi-provider data associated with additional telecommunications service providers. Based on a combination of the single-provider data and the multi-provider data, the device stacking detection computing system identifies a risk level for the request, e.g., a risk of device stacking fraud. The device stacking detection computing system provides, to the service provider computing system, data indicating the risk level. In some cases, the device stacking detection computing system provides alert data to additional service provider computing systems associated with the additional telecommunications service providers.

### RELATED APPLICATIONS

The present application claims priority to U.S. provisional application no. 63/738,958 for “Label generation techniques for device-stacking fraud detection” filed on Dec. 26, 2024, which is incorporated by reference herein in its entirety.

### TECHNICAL FIELD

This disclosure relates generally to the field of machine learning, and more specifically relates to machine learning techniques for detecting device stacking fraud in telecommunications industries.

### BACKGROUND

Device stacking is a type of fraud that can occur in telecommunications industries. Device stacking can occur when a consumer obtains multiple devices from service providers, such as by opening multiple new accounts to acquire devices without any initial payment. For example, a person can request multiple accounts in which device payment is arranged as a monthly payment in an account contract. Device stacking is fraudulent when the consumer abandons some or all of the new accounts, e.g., defaulting on the account contract and acquiring the devices without payment. In some cases, device stacking and related types of fraud can result in severe financial loss in the telecommunications industry, annually causing high revenue loss and inventory loss due to device theft and/or service theft.

In some cases, device stacking can occur within a relatively short time frame, such as within a few hours or days. In addition, device stacking can target multiple service providers, such as multiple telecommunication service providers. In some cases, the relatively short time frame and multiple-target aspects of device stacking can interfere with contemporary anti-fraud techniques.

It is desirable to develop fraud-detection techniques that can prevent or limit device stacking during a window of fraudulent activity, such as during a relatively short time frame in which service providers are targeted.

### SUMMARY

Various aspects of the present disclosure provide systems and methods for detecting device stacking fraud. According to certain embodiments, a computer-implemented method is executable by a processor device coupled to a memory device. The computer-implemented method includes operations that involve receiving single-provider data from a service provider computing system. The single-provider data indicates a digital device associated with a request to initiate account service. The single-provider data is generated during a current time period. The method includes further operations that involve determining multi-provider data based on the single-provider data. The multi-provider data excludes additional data generated during the current time period. The method includes further operations that involve generating a risk label based on a combination of the single-provider data and the multi-provider data. The risk label indicates a relative risk level related to the request to initiate account service. The method includes further operations that involve generating response data that is based on the risk label. The method includes further operations that involve providing the response data to the service provider computing system.

According to certain embodiments, a computing system comprises a processing device and a memory device in which instructions executable by the processing device are stored for causing the processing device to perform operations. The operations comprise receiving single-provider data from a service provider computing system. The single-provider data indicates a digital device associated with a request to initiate account service. The single-provider data is generated during a current time period. The operations further comprise determining multi-provider data based on the single-provider data. The multi-provider data excludes additional data generated during the current time period. The operations further comprise generating a risk label based on a combination of the single-provider data and the multi-provider data. The risk label indicates a relative risk level related to the request to initiate account service. The operations further comprise generating response data that is based on the risk label. The operations further comprise providing the response data to the service provider computing system.

According to certain embodiments, a non-transitory computer-readable storage medium includes program code that is executable by a processor device to cause a computing device to perform operations. The operations comprise receiving single-provider data from a service provider computing system. The single-provider data indicates a digital device associated with a request to initiate account service. The single-provider data is generated during a current time period. The operations further comprise determining multi-provider data based on the single-provider data. The multi-provider data excludes additional data generated during the current time period. The operations further comprise generating a risk label based on a combination of the single-provider data and the multi-provider data. The risk label indicates a relative risk level related to the request to initiate account service. The operations further comprise generating response data that is based on the risk label. The operations further comprise providing the response data to the service provider computing system.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings, where:

FIG. 1 is a block diagram depicting an example of a computing environment in which a device stacking detection computing system generates data identifying a risk level for device stacking fraud, according to certain embodiments;

FIG. 2 is a flow chart depicting an example of a process for generating data identifying a risk level for a device request, according to certain embodiments; and

FIG. 3 is a block diagram depicting an example of a computing system for implementing one or more techniques for determining device stacking fraud risk, according to certain embodiments.

### DETAILED DESCRIPTION

As discussed above, prior techniques for detecting fraud may not adequately prevent device stacking fraud, such as device stacking fraud that targets multiple telecommunications service providers. In some cases, device stacking can occur within a short time frame, such as within a few hours or days. In addition, device stacking can target multiple service providers, such as multiple telecommunications service providers. In some cases, the short time frame and multiple-target aspects of device stacking can interfere with contemporary anti-fraud techniques. For example, a malicious actor (e.g., a consumer with fraudulent intent) may visit multiple service locations for different mobile service providers during a single afternoon. In addition, the malicious actor can acquire several devices without payment by opening accounts at the multiple service locations. In this example, the malicious actor leverages the short time frame, e.g., a single afternoon, and the multiple targets, e.g., the different mobile service providers, to prevent data exchange among the mobile service providers and commit the fraudulent activity without detection. Contemporary anti-fraud techniques may be insufficient to prevent the fraudulent activity, since each of the different mobile service providers may identify the account/device acquisition as fraudulent only after several missed monthly payments (typically, much too late to address the loss of the devices).

Certain embodiments described herein provide for a device stacking detection computing system that includes a machine-learning model configured to determine device stacking fraud risk. For example, the device stacking detection computing system can receive query data from one or more service provider computing systems associated with various telecommunications service providers, such as providers for mobile telephone service. The device stacking detection computing system determines, based on the query data, additional data that describes requests for digital devices, such as data about a consumer who is requesting the digital devices. Based on one or more of the query data and the additional data describing the requests, the machine-learning model identifies a relative risk level for the requests, such as a risk label indicating a relatively low, medium, or high level of device stacking fraud risk. In addition, the device stacking detection computing system provides response data to the service provider computing systems from which the query data is received, such as response data indicating the relative risk level. In some implementations, one or more of the device stacking detection computing system or the service provider computing systems may generate account service decision data based on the response data, such as decision data to initiate or withhold an account service, or decision data to provide or withhold possession of a digital device. In some cases, the device stacking detection computing system provides alert data to one or more of the service provider computing systems, such as alert data indicating a potential occurrence of device stacking fraud. In some implementations, the service provider computing systems may perform anti-fraud techniques in response to receiving the alert data, such as responsive or precautionary anti-fraud techniques to reduce or prevent losses related to device stacking fraud.

Certain embodiments described herein provide technical advantages for efforts to reduce device stacking fraud. For example, a device stacking detection computing system can utilize particular rules to efficiently identify data describing multiple requests for multiple telecommunications service providers, such as multiple requests to initiate account services or to obtain possession of digital devices without payment. The utilization of the particular rules can generate new or additional data objects—e.g., response data, alert data—that can be used by service provider computing systems to reduce or prevent device stacking fraud. In some cases, the device stacking detection computing system can improve outcomes for one or more targeted telecommunications service providers, including improved outcomes such as reduced financial loss or equipment loss (e.g., digital devices fraudulently acquired). In addition, the device stacking detection computing system can increase accurate fraud detection during an ongoing fraud attempt, preventing or reducing further losses related to device stacking fraud.

In some implementations, a device stacking detection computing system can improve detection of device stacking fraud as compared to contemporary techniques for fraud detection. For example, contemporary fraud detection techniques may rely on historical patterns of data related to device acquisition, such as algorithmic analysis of multiple requests by a particular consumer to acquire devices during a relatively short period of time (e.g., a particular afternoon). However, the reliance on historical patterns of data may cause the contemporary fraud detection techniques to fail to identify early fraudulent activities, such as misidentifying an initial device acquisition in a sequence of as fraudulent device acquisitions. For example, during an attempted sequence of fraudulent device acquisitions (e.g., a device stacking fraud spree), contemporary fraud detection techniques may fail to correctly identify an initial device acquisition (e.g., the initial attempt in the fraud spree) as fraudulent. In addition, misidentifying early fraudulent activities can cause the loss of one or more devices, such as before the contemporary fraud detection techniques can identify a historical pattern of data indicating the in-progress fraud attempt.

In some implementations, techniques described herein for a device stacking detection computing system that utilizes multiple types of data as inputs to a machine-learning model can improve detection of device stacking fraud by identifying initial or early fraud attempts. For example, a device stacking detection computing system (such as described herein) can configure a machine-learning model to generate risk labels based on a combination of single-provider data and multi-provider data. In addition, the risk labels generated by the machine-learning model based on the combination of single-provider data and multi-provider data can more accurately identify initial or early fraud attempts, as compared to contemporary fraud detection techniques that require a data history of at least one fraudulent device acquisition. For example, the described device stacking detection computing system can improve detection of device stacking fraud by correctly identifying an initial attempt to fraudulently acquire a device (e.g., an initial device request in an attempted fraud spree), and may prevent the loss of the initial device (and any subsequent targeted devices) in an attempted fraud spree.

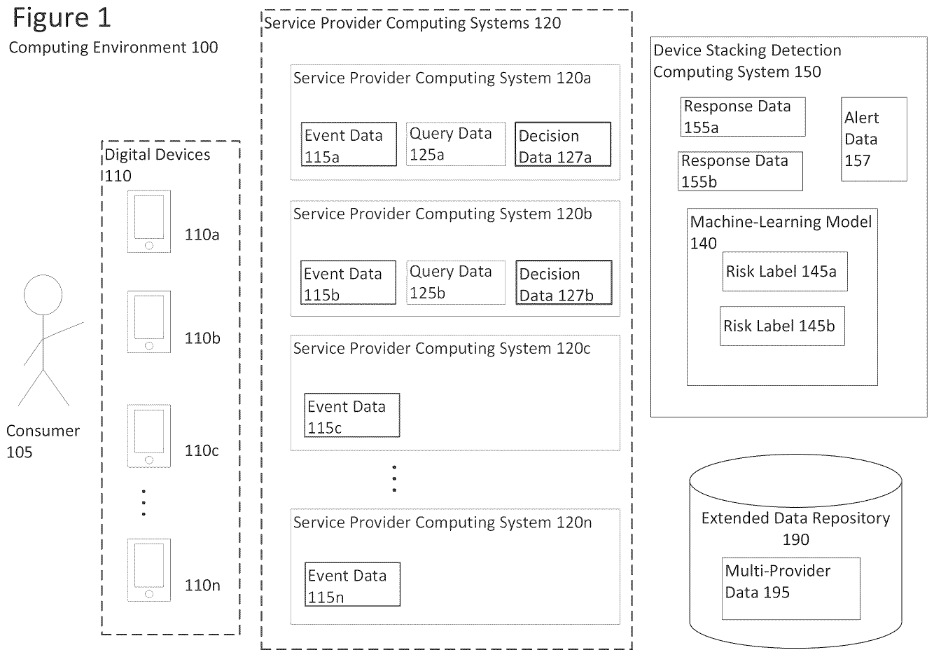

Referring now to the drawings, FIG. 1 is a diagram depicting an example of a computing environment 100 in which a device stacking detection computing system 150 generates data identifying a risk level, such as a risk level for device stacking fraud, in response to one or more queries received from service provider computing systems 120. In the computing environment 100, the service provider computing systems are operated by, or otherwise are associated with, telecommunications service providers that provide digital devices to consumers as a component of account service with the telecommunications service providers. For example, each of the telecommunications service providers associated with the service provider computing systems 120 may provide account service (e.g., mobile phone service, Internet service) to consumers. In addition, the provided account service may include (or may optionally include) a digital device (e.g., smartphone, digital tablet, Internet routing device) that is provided to a consumer who receives the account service from at least one of the telecommunications service providers.

In FIG. 1, each of the telecommunications service providers associated with the service provider computing systems 120 may be targeted for device stacking fraud attempts. For example, a malicious actor who desires to acquire digital devices without payment may target the telecommunications service providers, such as by visiting (or otherwise interacting with) multiple locations of one or more of the telecommunications service providers to request digital devices provided as a component of account service. In addition, the malicious actor may activate (or otherwise create) multiple account services to acquire multiple digital devices. In this example, the malicious actor is committing device stacking fraud by acquiring the multiple digital devices with little or no payment at the time of account service activation, then canceling (or otherwise abandoning) the account services without payment for the digital devices.

In FIG. 1, each of the telecommunications service providers associated with the service provider computing systems 120 may desire to reduce negative outcomes that result from being targeted in device stacking fraud attempts, such as loss of digital devices, increased overhead loss (e.g., maintenance of non-paying accounts, payment collection attempts), reputational loss, expenditure of computing resources associated with non-paying accounts, or other types of negative outcomes. In regard to FIG. 1, each of the service provider computing systems 120 is described as being associated with a respective (e.g., different) telecommunications service provider, but other implementations are possible, such as multiple service provider computing systems associated with a particular telecommunications service provider (e.g., various locations for a same provider), service provider computing systems associated with additional (e.g., non-telecommunications) service providers, or other types of computing systems associated with entities that can be targeted by device stacking fraud attempts.

In the computing environment 100 the service provider computing systems 120 include a service provider computing system 120a, a service provider computing system 120b, a service provider computing system 120c, and additional service provider computing systems through a service provider computing system 120n. Each of the service provider computing systems 120a through 120n is associated with a respective telecommunications service provider. In addition, each of the service provider computing systems 120a through 120n is configured to initiate account services for consumers who wish to become customers of the telecommunications service providers. For example, each of the service provider computing systems 120a through 120n may generate (or otherwise receive) data related to account service creation, such as one or more portions of event data 115 including event data 115a, event data 115b, event data 115c, and additional portions through event data 115n. For example, the event data 115 (or portions thereof) can include data describing a particular consumer (e.g., name, contact information, payment information, credit information), a particular requested account type (e.g., prepaid mobile phone service, monthly payment mobile phone service, monthly payment Internet service), or other types of data related to account service creation. In FIG. 1, the service provider computing system 120a generates the event data 115a, the service provider computing system 120b generates the event data 115b, the service provider computing system 120c generates the event data 115c, the service provider computing system 120n generates the event data 115n, and the additional service provider computing systems in the systems 120 respectively generate the additional portions of the event data 115.

In FIG. 1, one or more portions of the event data 115 may include data describing a particular digital device that is associated with the account service being created, such as a particular digital device from a group of digital devices 110. The group of digital devices 110 includes a digital device 110a, a digital device 110b, a digital device 110c, and additional digital devices through a digital device 110n. In some cases, each of the service provider computing systems 120a through 120n generates respective data describing at least one digital device that is identified (e.g., by a respective consumer who is requesting the account service) as being associated with the account service. For example, the service provider computing system 120a generates or modifies the event data 115a to include data describing the digital device 110a. In addition, the service provider computing systems 120b, 120c, and 120n respectively generate or modify the event data 115b, 115c, and 115n to include respective data describing the digital devices 110b, 110c, and 110n, and the additional service provider computing systems in the systems 120 respectively generate or modify the additional portions of the event data 115 to include respective data describing the additional digital devices from the group of digital devices 110.

In some implementations, each of the service provider computing systems 120 includes (or is otherwise configured to access) single-provider data, e.g., respective data that is accessible by a particular one of the service provider computing systems 120 or a telecommunications service provider associated with the particular one of the computing systems 120. In FIG. 1, the particular portions of the event data 115 are included in respective single-provider data for each particular service provider computing system 120 that generated a particular portion of the event data 115. For example, the event data 115a is included in single-provider data for the service provider computing system 120a, and the additional portions of event data 115b through 115n are included in respective single-provider data for the service provider computing systems 120b through 120n. In addition, each one of the service provider computing systems 120 is prevented from accessing the single-provider data for another one of the service provider computing systems 120. For example, the service provider computing system 120a is prevented from accessing the event data 115b through 115n and additional respective single-provider data for the service provider computing systems 120b through 120n, and the service provider computing systems 120b through 120n are prevented from accessing the event data 115a and additional respective single-provider data for the service provider computing system 120a. Examples of single-provider data for a particular service provider computing system or associated telecommunications service provider could include data describing account service creation (e.g., a respective portion of the event data 115), data describing existing account services of the associated telecommunications service provider, data describing payment histories of the existing account services (e.g., on-time payments, missed payments, aggregate financial loss for an account), data describing device usage of the existing account services (e.g., quantity or type of devices replaced, quantity or type of devices loaned), or other types of data that are internal to the particular service provider computing system or the associated telecommunications service provider.

In some implementations, the computing environment 100 includes at least one data repository, such as an extended data repository 190. In addition, the extended data repository 190 includes multi-provider data 195, such as multi-provider data describing one or more consumers who may wish to initiate an account service with one or more of the telecommunications service providers associated with the service provider computing systems 120. In addition, each of the service provider computing systems 120 is configured to access the multi-provider data 195, such as upon providing authenticated credentials to a computing system that operates the extended data repository 190. In some cases, the multi-provider data 195 includes data (e.g., describing consumers) provided by a multi-provider data source, e.g., a data source that is accessible by multiple ones of the service provider computing systems 120. Examples of multi-provider data sources could include computing systems associated with a telecommunications service provider industry group, a credit reporting agency, or other data sources accessible by multiple ones of the service provider computing systems 120. An example of a telecommunications service provider industry group could include the National Consumer Telecom & Utilities Exchange (“NCTUE”) or other organizations that operate (or are otherwise associated with) multi-provider data source computing systems. Examples of multi-provider data accessible by multiple service provider computing systems or multiple associated telecommunications service providers could include data describing credit information (e.g., credit scores), data describing existing account services of the multiple associated telecommunications service provider (e.g., assigned telephone numbers, assigned serial numbers for digital devices), or other types of data that are accessible by to the multiple service provider computing systems or the multiple associated telecommunications service providers. In some cases, the device stacking detection computing system 150, the service provider computing systems 120, the extended data repository 190, and one or more additional computing systems are configured to exchange data via one or more computing networks, such as a local or global area network.

In some implementations, a particular consumer, such as a consumer 105, may visit (or otherwise contact) multiple service locations of multiple telecommunications service providers to request account services. For example, the consumer 105 may visit service locations that include (or otherwise can communicate with) the service provider computing systems 120a, 120b, and 120c. In addition, the consumer 105 may interact with (or ask customer service personnel to interact with) the service provider computing systems 120a, 120b, and 120c to request account services with the associated telecommunications service providers. In some cases, requesting the account services may involve providing inputs (e.g., by the consumer 105, by customer service personnel on behalf of the consumer 105) to the service provider computing systems 120a, 120b, and 120c. In addition, the consumer may request possession of the digital devices 110a, 110b, and 110c, such as digital devices that are associated with the requested account services.

In FIG. 1, the consumer 105 may initially visit a first service location that includes the service provider computing system 120a to request a first account service and possession of the digital device 110a. Based on the request, such as based on data inputs describing the request by the consumer 105, the service provider computing system 120a generates the event data 115a. In FIG. 1, the event data 115a describes the request to initiate the first account service and further describes the digital device 110a. In addition, the service provider computing system 120a generates query data 125a. The query data 125a can include (or otherwise indicate) at least some of the event data 115a. In some cases, the query data 125a can include (or otherwise indicate) additional single-provider data that is accessible by the service provider computing system 120a, such as single-provider data describing additional account services held by the consumer 105 with the telecommunications service provider associated with the computing system 120a.

In some implementations, the service provider computing system 120a provides the query data 125a to the device stacking detection computing system 150. In addition, the device stacking detection computing system 150 includes a machine-learning model 140 that is configured to determine a device stacking fraud risk associated with received query data. FIG. 1 describes the machine-learning model 140 as including a particular trained machine-learning model, but other implementations are possible, such as multiple machine-learning models that are trained (e.g., trained separately, trained together) to determine a device stacking fraud risk. Examples of machine-learning models (or other techniques) that could be trained to determine a device stacking fraud risk could be an XGBoost machine-learning model or a rules-based machine-learning model configured to determine rules via artificial intelligence (e.g., SKOPE rules), but other implementations are possible.

Responsive to receiving the query data 125a, the device stacking detection computing system 150 may access the extended data repository 190, such as to identify a portion of the multi-provider data 195 associated with the consumer 105 described by the query data 125a. In addition, the device stacking detection computing system 150 may determine if additional query data describing the consumer 105 has been recently received, such as additional query data describing additional requests for account service or possession of digital devices. In this example, the device stacking detection computing system 150 determines that no additional query data describing the consumer 105 has been recently received, e.g., no query data describing the consumer 105 had been received by the device stacking detection computing system 150 during a recent window of time prior to the query data 125a. Examples of a recent window of time could include query data received during a quantity of hours (e.g., 8-hour time window), a quantity of days (e.g., a 3-day time window), or other windows of time associated with device stacking fraud risk. Based on one or more of the query data 125a and the portion of the multi-provider data 195 associated with the consumer 105, the machine-learning model 140 determines a first device stacking fraud risk associated with the query data 125a. In addition, the machine-learning model 140 generates a risk label 145a indicating the first device stacking fraud risk. For example, the risk label 145a could include data identifying a relative risk level related to the query data 125a, e.g., a low, medium, or high risk level for device stacking fraud. In this example, the risk label 145a indicates a low relative risk level.

In the computing environment 100, the device stacking detection computing system 150 generates response data 155a based on the risk label 145a. For example, the response data 155a may include (or otherwise indicate) the low relative risk level identified by the risk label 145a. In addition, the device stacking detection computing system 150 provides the response data 155a to the service provider computing system 120a. The service provider computing system 120a may be configured to generate account service decision data based (at least in part) on the response data 155a. For example, based on the low relative risk level indicated by the response data 155a, the service provider computing system 120a may generate decision data 127a to initiate the requested first account service and provide possession of the digital device 110a to the consumer 105. In some implementations, the device stacking detection computing system 150 can generate account service decision data in addition to (or instead of) one or more of the service provider computing systems 120. In addition, the device stacking detection computing system 150 can provide the account service decision data to one or more of the service provider computing systems 120. For example, based on the response data 155a, the device stacking detection computing system 150 can generate and provide decision data to initiate a requested account service and provide possession of a digital device, such as decision data that configures the service provider computing system 120a to initiate the requested first account service and provide possession of the digital device 110a to the consumer 105.

In FIG. 1, the consumer 105 may subsequently visit a second service location that includes the service provider computing system 120b to request a second account service and possession of the digital device 110b. Based on the request, such as based on data inputs describing the request by the consumer 105, the service provider computing system 120b generates the event data 115b. In FIG. 1, the event data 115b describes the request to initiate the second account service and further describes the digital device 110b. In addition, the service provider computing system 120b generates query data 125b. The query data 125b can include (or otherwise indicate) at least some of the event data 115b. In some cases, the query data 125b can include (or otherwise indicate) additional single-provider data that is accessible by the service provider computing system 120b, such as single-provider data describing additional account services held by the consumer 105 with the telecommunications service provider associated with the computing system 120b.

In some implementations, the service provider computing system 120b provides the query data 125b to the device stacking detection computing system 150. Responsive to receiving the query data 125b, the device stacking detection computing system 150 may access the extended data repository 190, such as to identify a portion of the multi-provider data 195 associated with the consumer 105 described by the query data 125b. In addition, the device stacking detection computing system 150 may determine if additional query data describing the consumer 105 has been recently received. In this example, the device stacking detection computing system 150 determines that the query data 125a has been recently received, e.g., received during a recent window of time prior to the query data 125b. In addition, the device stacking detection computing system 150 determines that the query data 125a describes the request for the first account service and possession of the digital device 110a. Based on one or more of the query data 125a and the portion of the multi-provider data 195 associated with the consumer 105, and the query data 125a, the machine-learning model 140 determines a second device stacking fraud risk associated with the query data 125b. In addition, the machine-learning model 140 generates a risk label 145b indicating the second device stacking fraud risk. For example, the risk label 145b could include data identifying a relative risk level related to the query data 125b. In this example, the risk label 145b indicates a medium relative risk level.

In the computing environment 100, the device stacking detection computing system 150 generates response data 155b based on the risk label 145b. For example, the response data 155b may include (or otherwise indicate) the medium relative risk level identified by the risk label 145b. In addition, the device stacking detection computing system 150 provides the response data 155b to the service provider computing system 120b. The service provider computing system 120b may be configured to generate account service decision data based (at least in part) on the response data 155b. For example, based on the medium relative risk level indicated by the response data 155b, the service provider computing system 120b may generate decision data 127b to withhold the requested second account service and withhold possession of the digital device 110b from the consumer 105. In some cases, the decision data 127b generated by the service provider computing system 120b may indicate one or more responsive or precautionary anti-fraud measures. For instance, the service provider computing system 120b could provide, such as to customer service personnel interacting with the computing system 120b, that payment is required from the consumer 105 prior to providing possession of the digital device 110b. In some implementations, the device stacking detection computing system 150 can generate or provide account service decision data in addition to (or instead of) one or more of the service provider computing systems 120. For example, based on the response data 155b, the device stacking detection computing system 150 can generate and provide additional decision data to withhold an additional requested account service and withhold possession of an additional digital device, such as additional decision data that configures the service provider computing system 120b to withhold the requested second account service and withhold possession of the digital device 110b to the consumer 105. In some cases, the device stacking detection computing system 150 can generate or provide account service decision data that includes (or otherwise indicates) one or more anti-fraud measures, such as responsive or precautionary anti-fraud measures.

In some cases, the device stacking detection computing system 150 generates alert data, such as alert data 157, based on one or more of the response data 155b or the risk label 145b. In addition, the device stacking detection computing system 150 provides the alert data 157 to one or more of the service provider computing systems 120. For example, the device stacking detection computing system 150 may determine additional query data that is related to (e.g., identifies a same consumer) query data that is used by the machine-learning model 140 to determine a medium or high risk level. In addition, the device stacking detection computing system 150 may identify and provide the alert data 157 to one or more service provider computing systems from which the additional query data was received. In FIG. 1, for example, the device stacking detection computing system 150 identifies the query data 125a as describing the same consumer 105 as described by the query data 125b, for which the risk label 145b indicates the medium relative risk level. In addition, the device stacking detection computing system 150 determines that the service provider computing system 120a provided (or is otherwise associated with) the query data 125a. Responsive to determining that the service provider computing system 120a provided the query data 125a, the device stacking detection computing system 150 provides the alert data 157 to the service provider computing system 120a. In some cases, the device stacking detection computing system 150 provides the alert data 157 to additional ones of the service provider computing systems 120. For example, the device stacking detection computing system 150 may determine that the service provider computing system 120c shares one or more characteristics with the service provider computing systems 120a and 120b, such as service locations in a same geographical region, providing digital devices similar to the digital devices 110a and 110b, or other characteristics that could indicate an increased risk of targeting for potential device stacking fraud. Responsive to determining that the service provider computing system 120c shares characteristics with the computing systems 120a and 120b, the device stacking detection computing system 150 provides the alert data 157 to the service provider computing system 120c.

In some cases, one or more of the systems 120 is configured to perform anti-fraud measures in response to receiving the alert data 157. For example, responsive to receiving the alert data 157, the service provider computing system 120a may perform responsive anti-fraud measures to try to reduce loss related to the digital device 110a. Examples of responsive anti-fraud measures could include locking a digital device that is in possession of a consumer without having received payment, canceling or otherwise limiting account service for a consumer who has possession of an unpaid digital device, or other techniques to reduce potential losses related to device stacking fraud. In addition, responsive to receiving the alert data 157, one or more of the service provider computing systems 120b and 120c may perform precautionary anti-fraud measures to try to prevent loss related to the digital devices 110b or 110c. Examples of precautionary anti-fraud measures could include requiring full or partial payment for a digital device prior to providing possession to a consumer, requesting an increased scrutiny (e.g., a credit check, a background check) for a consumer who is requesting possession of a digital device, or other techniques to prevent potential losses related to device stacking fraud.

In some implementations, generating one or more of response data, decision data, or alert data via a device stacking detection computing system can improve security for at least one computing device or system associated with a telecommunications service provider, such as by preventing or reducing losses related to a digital device or a service provider computing system. For example, based on one or more of the techniques described herein, a device stacking detection computing system can more accurately (e.g., as compared to contemporary device stacking fraud detection techniques) determine a relative risk level associated with a request to initiate account service or receive possession of a digital device. In addition, the example device stacking detection computing system can utilize a combination of single-provider data and multi-provider data as input data for a machine-learning model. In some cases, the use of a machine-learning model and the combination of single-provider data and multi-provider data can enable the example device stacking detection computing system to generate response data, decision data, or alert data more rapidly as compared to contemporary techniques for automated device stacking fraud detection, such as contemporary techniques that use algorithmic analysis of historical data. For example, the example device stacking detection computing system and machine-learning model could generate one or more of response data, decision data, or alert data identifying an initial fraud attempt in a sequence of fraudulent device acquisitions (e.g., a device stacking fraud spree), as compared to a contemporary algorithmic analysis technique that requires analysis of the initial fraud attempt to identify one or more subsequent fraud attempts in the sequence. In addition, the example device stacking detection computing system and machine-learning model could prevent loss of the initial device that is targeted in the sequence of fraudulent device acquisitions, reducing losses of physical equipment (e.g., the initial targeted device), losses of computing resources (e.g., computing resources expended on an account opened fraudulently), or other types of losses.

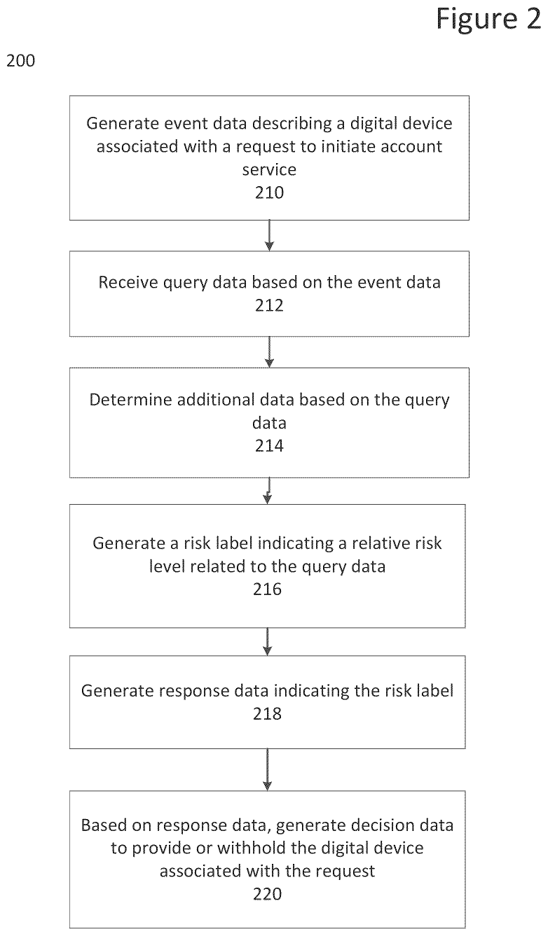

FIG. 2 is a flow chart depicting an example of a process 200 for generating data identifying a risk level for a device request, such as a risk level for device stacking fraud. In some embodiments, such as described in regards to FIG. 1, a computing device executing a device stacking detection computing system implements one or more operations described in FIG. 2, by executing suitable program code. For illustrative purposes, the process 200 is described with reference to the examples depicted in FIG. 1. Other implementations, however, are possible.

At block 210, the process 200 involves generating event data that describes one or more digital devices. For example, the event data can be generated by a service provider computing system that is associated with a telecommunications service provider. In addition, the generated event data can describe a digital device that is indicated in a consumer request, such as a consumer request to receive the digital device and initiate account service with the telecommunications service provider. In some cases, the event data can describe one or more consumers who are associated with the request. For example, the service provider computing system 120a generates the event data 115a based on information received from the consumer 105. In addition, the event data 115a describes the digital device 110a and a request by the consumer 105 to initiate account service with the telecommunications service provider associated with the service provider computing system 120a.

At block 212, the process 200 involves receiving query data that is based on the event data. For example, a device stacking detection computing system could receive query data that is generated by the service provider computing system. In some cases, the service provider computing system generates the query data based on at least a portion of the event data, such as a portion of the event data describing one or more of the request for account service, the digital device, or the consumer associated with the request. In some cases, the query data includes a secured modification of the event data, such as secured data that is encrypted, anonymized, hashed, or otherwise modified using techniques to increase data security. For example, the device stacking detection computing system 150 receives the query data 125a from the service provider computing system 120a. In addition, the service provider computing system 120a generates the query data 125a based on the event data 115a.

In some cases, the block 212 involves receiving, by the device stacking detection computing system, single-provider data. For example, one or more of the query data or the event data could include (or otherwise indicate) single-provider data generated by (or otherwise associated with) the service provider computing system. In some cases, the single-provider data can include (or otherwise indicate) one or more of the request for account service, the digital device, or the consumer associated with the request. In some cases, the single-provider data is associated with the telecommunications service provider. In addition, one or more additional telecommunications service providers are prevented from accessing the single-provider data (e.g., the single-provider data is internal or otherwise protected by the telecommunications service provider associated with the service provider computing system). In some cases, the single-provider data is generated during a particular time period, such as a current time period in which the service provider computing system receives the request to receive the digital device and initiate account service. For example, the service provider computing system 120a may generate one or more of the query data 125a or the event data 115a during a particular time period, e.g., during an afternoon (or other time suitable time period) in which the consumer 105 requests the digital device 110a.

At block 214, the process 200 involves determining additional data based on the query data, such as additional data describing one or more of the request for account service, the digital device, or the consumer associated with the request. In some cases, the device stacking detection computing system identifies, such as from multi-provider data, additional data describing the consumer who requested the account service or the digital device, such as credit data or other types of consumer data. In some cases, the device stacking detection computing system identifies additional query data describing additional requests for account service or digital devices. For example, the device stacking detection computing system may determine that multiple sets of query data have been received, e.g., by the device stacking detection computing system, during a recent window of time, such as a span of a few hours. In addition, the device stacking detection computing system may determine that the multiple sets of query data also describe the consumer, e.g., the consumer has provided multiple requests for account service or digital devices during the recent window of time. For example, the device stacking detection computing system 150 may determine that the consumer 105 is described by the query data 125b and also the query data 125a. In some cases, the device stacking detection computing system may determine one or more additional characteristics that are similar among the received query data and the determined additional query data, such as characteristics describing similar digital devices, similar geographic regions of service provider computing systems, or other types of characteristics that may be similar among query data.

In some cases, such as in regard to the block 214, the additional data determined by the device stacking detection computing system is multi-provider data, such as at least a portion of the multi-provider data 195. In some cases, the multi-provider data is associated with one or more additional telecommunications service providers. In some cases, the multi-provider data excludes the single-provider data. In addition, the multi-provider data can exclude additional data generated during the particular time period, such as the current time period in which the single-provider data is generated. For example, the multi-provider data 195 could include historical data that is generated during a previous time period (e.g., a previous month, a previous day) that occurred before the service provider computing system 120a received the request for the digital device 110a. In some cases, the single-provider data and the multi-provider data are each related to a particular user (e.g., the consumer 105). In some cases, the multi-provider data excludes any additional data describing additional device requests made during the particular time period, such as excluding any additional device requests made by the user during the current time period in which the single-provider data is generated. For example, the multi-provider data 195 could exclude the event data 115 and other event data generated during the example afternoon (or other time suitable time period) in which the consumer 105 requests the digital device 110a.

At block 216, the process 200 involves generating a risk label, or other risk data, that describes a relative risk level associated with the received query data, such as a risk label indicating a low, medium, or high relative risk level. FIG. 2 describes the relative risk level as having low, medium, or high levels, but other implementations are possible, such as a relative risk level indicated via a number (e.g., percentage, scale from 0-5) or other techniques to indicate a relative risk level. In some cases, the risk label indicates a relative risk level of the request (e.g., for the digital device) described by the query data. In some implementations, one or more machine-learning models included in the device stacking detection computing system determine the risk label based on one or more of the received query data, the additional data describing the consumer, or the additional query data (if identified) describing the additional requests. For example, the machine-learning model 140 in the device stacking detection computing system 150 generates the risk label 145a based on the query data 125a and the portion of the multi-provider data 195 associated with the consumer 105. In addition, the machine-learning model 140 generates the risk label 145b based on the query data 125b, the portion of the multi-provider data 195 associated with the consumer 105, and the query data 125a.

In some cases, the block 212 involves combining the single-provider data and the multi-provider data. In some cases, the risk label is generated based on the combination of the single-provider data and the multi-provider data. For example, the one or more machine-learning models included in the device stacking detection computing system may receive one or more of the single-provider data, the multi-provider data, or a combination thereof as inputs. In addition, the one or more machine-learning models may calculate the relative risk level based on one or more of the received inputs, such as the combination of the single-provider data and the multi-provider data. For example, the machine-learning model 140 may generate the risk label 145a (or the risk label 145b) based on a respective combination of the query data 125a (or the query data 125b) with the multi-provider data 195 (or a portion thereof).

At block 218, the process 200 involves generating response data based on the generated risk label. such as a risk label generated by the device stacking detection computing system. In addition, the device stacking detection computing system may provide the response data to at least one additional computing system, such as the service provider computing system from which the query data is received. In some cases, the block 218 involves receiving the response data indicating the risk label or other risk data, such as response data received by the service provider computing system that provided the query data to the device stacking detection computing system. In some cases, the device stacking detection computing system generates the response data based on the risk label determined by the machine-learning model. In addition, the device stacking detection computing system provides the response data to the service provider computing system. For example, the device stacking detection computing system 150 generates the response data 155a based on the risk label 145a and provides the response data 155a to the service provider computing system 120a. In addition, the device stacking detection computing system 150 generates the response data 155b based on the risk label 145b and provides the response data 155b to the service provider computing system 120b.

In some implementations, the process 200 involves generating, providing, or receiving alert data, such as at block 218. In some cases, the device stacking detection computing system generates the alert data based on the relative risk level determined via the machine-learning model. For example, the device stacking detection computing system 150 generates the alert data 157 based on one or more of the risk labels 145a or 145b. In some cases, the device stacking detection computing system provides the alert data to one or more service provider computing systems. In some cases, the device stacking detection computing system may determine at least one service provider computing system that has provided query data during the recent window of time, such as the query data on which the relative risk level was determined or the additional query data describing the multiple requests provided by the consumer. In addition, the device stacking detection computing system may determine at least one service provider computing system that shares one or more characteristics with the service provider computing systems which provided the query data or the additional query data. For example, the device stacking detection computing system 150 provides the alert data 157 to the service provider computing systems 120a and 120b, based on a determination that the computing systems 120a and 120b provided the query data 125a and 125b. In addition, the device stacking detection computing system 150 provides the alert data 157 to the service provider computing system 120c, based on a determination that the computing system 120c shares one or more characteristics with the computing systems 120a or 120b.

At block 220, the process 200 involves generating decision data based on the response data, such as account service decision data. For example, one or more of the device stacking detection computing system or the service provider computing system can generate the decision data based on the relative risk level indicated by the response data. In some cases, the device stacking detection computing system can provide the decision data to the service provider computing system. In some cases, the decision data indicates one or more actions related to the consumer request to receive the digital device and initiate account service with the telecommunications service provider. In addition, the decision data can indicate one or more anti-fraud measures. As an example, if the response data indicates a relatively low risk of device stacking fraud, the decision data may indicate an action of providing possession of the digital device to the consumer based on a monthly payment plan (e.g., credit-based installment payment). As another example, if the response data indicates a relatively medium risk of device stacking fraud, the decision data may indicate one or more actions to perform prior to providing possession of the digital device to the consumer, such as receiving partial upfront payment or performing one or more additional checks (e.g., credit check, background check, verify payment type). As another example, if the response data indicates a relatively high risk of device stacking fraud, the decision data may indicate one or more actions to modify the consumer request (e.g., suggest modifications to the consumer), such as receiving full upfront payment or selecting a different digital device for the requested account service. For example, the service provider computing system 120a generates account service decision data based on the low relative risk level indicated by the response data 155a, such as the decision data 127a to initiate the requested first account service and provide possession of the digital device 110a to the consumer 105. In addition, the service provider computing system 120b generates account service decision data based on the medium relative risk level indicated by the response data 155b, such as the decision data 127b indicating one or more of withholding the requested second account service, withholding possession of the digital device 110b, or performing a precautionary anti-fraud measure to receive payment from the consumer 105 prior to providing possession of the digital device 110b.

In some implementations, the process 200 involves performing one or more anti-fraud measures based on received alert data, such as at block 220. For example, the service provider computing system can receive the alert data that is generated and provided by the device stacking detection computing system. Responsive to receiving the alert data, the service provider computing system identifies one or more anti-fraud measures, such as precautionary or responsive anti-fraud measures. For example, responsive to receiving the alert data 157, the service provider computing system 120a may perform responsive anti-fraud measures to try to reduce loss related to the digital device 110a. In addition, responsive to receiving the alert data 157, one or more of the service provider computing systems 120b and 120c may perform precautionary anti-fraud measures to try to prevent loss related to the digital devices 110b or 110c.

In some implementations, one or more operations related to the process 200 are performed by a device stacking detection computing system, such as the device stacking detection computing system 150. In some implementations, one or more operations related to the process 200 are performed by a service provider computing system, such as one or more of the service provider computing systems 120. Other implementations, however, are possible.

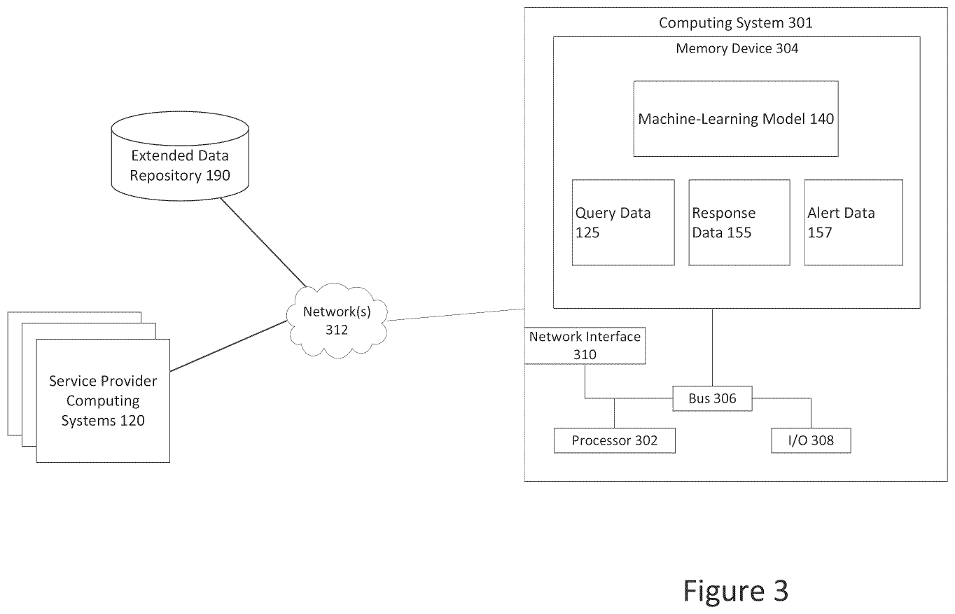

Any suitable computing system or group of computing systems can be used for performing the operations described herein. For example, FIG. 3 is a block diagram depicting an example of a computing system, such as a device stacking detection computing system, configured for implementing one or more techniques for determining device stacking fraud risk, according to certain embodiments.

The depicted example of a computing system 301 includes one or more processors 302 communicatively coupled to one or more memory devices 304. The processor 302 executes computer-executable program code or accesses information stored in the memory device 304. Examples of processor 302 include a microprocessor, an application-specific integrated circuit (“ASIC”), a field-programmable gate array (“FPGA”), or other suitable processing device. The processor 302 can include any number of processing devices, including one.

The memory device 304 includes any suitable non-transitory computer-readable medium for storing the machine-learning model 140, query data 125 (e.g., the query data 125a or 125b), response data 155 (e.g., the response data 155a or 155b), the alert data 157, and other received or determined values or data objects. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript.

The computing system 301 may also include a number of external or internal devices such as input or output devices. For example, the computing system 301 is shown with an input/output (“I/O”) interface 308 that can receive input from input devices or provide output to output devices. A bus 306 can also be included in the computing system 301. The bus 306 can communicatively couple one or more components of the computing system 301.

The computing system 301 executes program code that configures the processor 302 to perform one or more of the operations described above with respect to FIGS. 1-2. The program code includes operations related to, for example, one or more of the machine-learning model 140, the query data 125, the response data 155, the alert data 157, or other suitable applications or memory structures that perform one or more operations described herein. The program code may be resident in the memory device 304 or any suitable computer-readable medium and may be executed by the processor 302 or any other suitable processor. In some embodiments, the program code described above, the machine-learning model 140, the query data 125, the response data 155, and the alert data 157 are stored in the memory device 304, as depicted in FIG. 3. In additional or alternative embodiments, one or more of the machine-learning model 140, the query data 125, the response data 155, the alert data 157, and the program code described above are stored in one or more memory devices accessible via a data network, such as a memory device accessible via a cloud service.

The computing system 301 depicted in FIG. 3 also includes at least one network interface 310. The network interface 310 includes any device or group of devices suitable for establishing a wired or wireless data connection to one or more data networks 312. Non-limiting examples of the network interface 310 include an Ethernet network adapter, a modem, and/or the like. The computing system 301 is able to communicate with one or more of the extended data repository 190 or the service provider computing systems 120 using the network interface 310.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied —for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A computer-implemented method executable by a processor device coupled to a memory device, the computer-implemented method including operations comprising:
receiving, from a service provider computing system, single-provider data indicating a digital device associated with a request to initiate account service, wherein the single-provider data is generated during a current time period;
determining, based on the single-provider data, multi-provider data that excludes additional data generated during the current time period;
generating, based on a combination of the single-provider data and the multi-provider data, a risk label indicating a relative risk level related to the request to initiate account service;
generating response data that is based on the risk label; and
providing the response data to the service provider computing system.

2. The method of claim 1, wherein:
the response data provided to the service provider computing system includes decision data, and
the decision data is used to configure the service provider computing system to withhold initiation of the account service indicated by the single-provider data.

3. The method of claim 1, wherein:
the single-provider data is associated with a particular telecommunications service provider,
the multi-provider data is associated with a plurality of additional telecommunications service providers, and
the plurality of additional telecommunications service providers are prevented from accessing the single-provider data associated with the particular telecommunications service provider.

4. The method of claim 1, the included operations further comprising:
generating alert data based on one or more of the response data or the risk label; and
providing the alert data to one or more additional computing systems.

5. The method of claim 1, wherein the single-provider data is included in query data received from the service provider computing system.

6. The method of claim 1, wherein:
the risk label is generated via a machine-learning model, and
the machine-learning model is configured to calculate the relative risk level based on the combination of the single-provider data and the multi-provider data.

7. The method of claim 1, wherein:
the single-provider data and the multi-provider data are associated with a consumer, and
the consumer is associated with the request to initiate account service.

8. A computing system comprising:
a processing device; and
a memory device in which instructions executable by the processing device are stored for causing the processing device to perform operations comprising:
receiving, from a service provider computing system, single-provider data indicating a digital device associated with a request to initiate account service, wherein the single-provider data is generated during a current time period;
determining, based on the single-provider data, multi-provider data that excludes additional data generated during the current time period;
generating, based on a combination of the single-provider data and the multi-provider data, a risk label indicating a relative risk level related to the request to initiate account service;
generating response data that is based on the risk label; and
providing the response data to the service provider computing system.

9. The computing system of claim 8, wherein:
the response data provided to the service provider computing system includes decision data, and
the decision data is used to configure the service provider computing system to withhold initiation of the account service indicated by the single-provider data.

10. The computing system of claim 8, wherein:
the single-provider data is associated with a particular telecommunications service provider,
the multi-provider data is associated with a plurality of additional telecommunications service providers, and
the plurality of additional telecommunications service providers are prevented from accessing the single-provider data associated with the particular telecommunications service provider.

11. The computing system of claim 8, the operations further comprising:
generating alert data based on one or more of the response data or the risk label; and
providing the alert data to one or more additional computing systems.

12. The computing system of claim 8, wherein the single-provider data is included in query data received from the service provider computing system.

13. The computing system of claim 8, wherein:
the risk label is generated via a machine-learning model, and
the machine-learning model is configured to calculate the relative risk level based on the combination of the single-provider data and the multi-provider data.

14. A non-transitory computer-readable storage medium having program code that is executable by a processor device to cause a computing device to perform operations, the operations comprising:
receiving, from a service provider computing system, single-provider data indicating a digital device associated with a request to initiate account service, wherein the single-provider data is generated during a current time period;
determining, based on the single-provider data, multi-provider data that excludes additional data generated during the current time period;
generating, based on a combination of the single-provider data and the multi-provider data, a risk label indicating a relative risk level related to the request to initiate account service;
generating response data that is based on the risk label; and
providing the response data to the service provider computing system.

15. The non-transitory computer-readable storage medium of claim 14, wherein:
the response data provided to the service provider computing system includes decision data, and
the decision data is used to configure the service provider computing system to withhold initiation of the account service indicated by the single-provider data.

16. The non-transitory computer-readable storage medium of claim 14, wherein:
the single-provider data is associated with a particular telecommunications service provider,
the multi-provider data is associated with a plurality of additional telecommunications service providers, and
the plurality of additional telecommunications service providers are prevented from accessing the single-provider data associated with the particular telecommunications service provider.

17. The non-transitory computer-readable storage medium of claim 14, the operations further comprising:
generating alert data based on one or more of the response data or the risk label; and
providing the alert data to one or more additional computing systems.

18. The non-transitory computer-readable storage medium of claim 14, wherein the single-provider data is included in query data received from the service provider computing system.

19. The non-transitory computer-readable storage medium of claim 14, wherein:
the risk label is generated via a machine-learning model, and
the machine-learning model is configured to calculate the relative risk level based on the combination of the single-provider data and the multi-provider data.

20. The non-transitory computer-readable storage medium of claim 14, wherein:
the single-provider data and the multi-provider data are associated with a consumer, and
the consumer is associated with the request to initiate account service.
